(19) United States
(12) Patent Application Publication
(10) Pub. No.: US 2021/0199438 A1
(43) Pub. Date: Jul. 1, 2021

(54) HEADING INITIALIZATION METHOD FOR TILT RTK

(71) Applicant: Wuhan University, Wuhan (CN)

(72) Inventors: Qijin CHEN, Wuhan (CN); Xiaoji NIU, Wuhan (CN); Huan LIN, Wuhan (CN); Ruonan GUO, Wuhan (CN); Changxin LAI, Wuhan (CN)

(21) Appl. No.: 17/012,794

(22) Filed: Sep. 4, 2020

(30) Foreign Application Priority Data
Dec. 27, 2019 (CN) 201911380356.1

(51) Int. Cl. G01C 21/16; G01C 21/20

(52) U.S. Cl. CPC G01C 21/183; G01C 21/20; G01C 21/165

(57) ABSTRACT

A method for calculating an INS initial heading angle error includes comparing an RTK trajectory with an INS trajectory under a tilt RTK application scenario, which may achieve heading angle initialization with an accuracy of 1 deg within 2 seconds. An INS trajectory estimation method eliminates accelerometers, and a large initial gyro bias is compensated by averaging the stationary gyro measurement at the beginning of the measurement to ensure the accuracy of the estimated INS trajectory. A rather short initialization duration also greatly improves the measurement efficiency. Compared with common heading initialization methods for the tilt RTK, the inventive method eliminates magnetometers and thus prevents interference from magnetic fields, obtaining stronger adaptability in complex environments.

### CROSS-REFERENCE TO RELATED APPLICATION

This application claims priority under 35 U.S.C. § 119(b) to Chinese Application No. 201911380356.1, filed Dec. 27, 2019, the disclosure of which is incorporated herein by reference in its entirety.

### FIELD OF THE INVENTION

The present disclosure belongs to the field of initial heading alignment for a MEMS INS/GNSS integrated navigation system, and in particular relates to a rapid and accurate heading initialization method for RTK receivers with tilt compensation function.

### BACKGROUND OF THE INVENTION

As an example of a dead reckoning navigation system, an inertial navigation system (INS) has advantages of complete autonomy, high reliability, good dynamic performance, and the like. However, since errors thereof may accumulate over time, other navigation aiding is generally needed to assist the INS for correction. Compared with the INS, a global navigation satellite system (GNSS) may realize positioning with a high accuracy for a long term, and errors thereof do not accumulate over time; but it has disadvantages of low output frequency, inability to perform continuous positioning, inability to output attitude information, and the like. An INS/GNSS integrated navigation system formed by combining the two systems together is capable of providing high-bandwidth navigation parameters, which are continuous and complete and have a high accuracy both in a long term and a short term.

The INS/GNSS integrated navigation system is applicable in many fields. Taking the tilt RTK application scenario as an example, an MEMS INS/GNSS integrated navigation system may be formed by adding a low-cost micro-electro-mechanical system (MEMS) inertial navigation device, and tilt compensation may be performed with the attitude information output by the MEMS INS, which thereby breaks through the traditional RTK measurement mode and greatly improves the operation efficiency.

The traditional GNSS RTK (real-time kinematic) is able to achieve a centimeter-level positioning accuracy and applicable in high-precision position surveying and mapping. However, during the traditional RTK measurement process, the measurement pole shall be strictly levelled and held vertically, which makes some points (such as, a root point of a wall, an inner point of an underground pipe, etc.) unable to be surveyed and mapped and causes a low operation efficiency. In recent two years, a “tilt RTK”, which is formed by integrating an inertial measurement unit in the RTK equipment, may compensate the position of an antenna phase center to a pole tip through attitude angles given by the INS or the integrated GNSS/INS, so that coordinates of difficult points may be determined, and a tiltable RTK measurement is realized. During the tilt RTK measurement process, the measurement pole does not need to place vertically, nor need to keep stationary for a long time, which expands the application range of RTK and meanwhile greatly improves the measurement efficiency.

During the application process of the GNSS/INS integrated navigation system including the tilt RTK, the heading initialization is a key point. At the first epoch, it is necessary to perform the initialization because the previous navigation results are required to serve as initial values for navigation solution of the INS. For the INS, initialization of the position and velocity is relatively simple and may be directly provided by external information sources (such as GNSS); whereas initialization of the attitude is relatively complicate and generally provided by the external information or obtained through self-alignment. When a vehicle remains stationary, other types of INS, except the inertial navigation system with extremely low precision, may all achieve initialization of the roll angle and pitch angle through self-alignment, the essence of which is to sense the gravity vector with an accelerometer. The most difficult issue during the attitude initialization process is the initialization of heading angle. During the self-alignment, a gyro is employed to sense the earth's rotation vector for determining the north direction. Thus, there is a rather high requirement on accuracy of the gyro, and the gyro bias must be less than 15 deg/h of the earth's rotation angular velocity, which is especially unsuitable for the low-cost and low-precision MEMS INS. In addition, accuracy of the heading angle obtained from the external information sources is not desirable. For example, a magnetometer is extremely susceptible to electromagnetic interference from external magnetic fields, and attitude determination results of a multi-antenna GNSS device often contain a lot of noise.

Of course, a specific heading initialization method may be available in some specific application scenarios. For example, for most car navigations, the heading initialization may be performed through dynamic alignment, which requires driving at a certain speed when the vehicle is not turning and aligning the forward direction with an x-axis of the carrier. However, for the application of low-speed motions (such as, agricultural tractors) and handheld devices, the heading initialization is still a key point and an urgent problem to be solved. Taking a tilt RTK application scenario as an example, the latest generation tilt RTK survey meter S6II of Stonex determines the north direction through magnetic calibration and thereby is susceptible to interference and influence of magnetic fields; and the inertial navigation RTK of CHCNAV requires the handheld device to advance 10 meters, and the north-seeking is completed with the position and speed of GNSS. Thus, the existing solutions have two obvious shortcomings. One is that the north-seeking by a magnetometer is susceptible to interference of magnetic fields and thereby has a poor reliability. The other is that the initialization may cost several seconds or even a dozen seconds, which takes a rather long time, and accuracy of the heading initialization may only reach the available level after moving several meters or even a dozen meters, the efficiency of which may still be improved.

In summary, in the tilt RTK application scenario, it is essential to provide accurate attitudes of the measurement pole through INS or GNSS/INS. Since the MEMS INS cannot implement north-seeking (that is, heading initialization) by itself, how to obtain the initial attitude of the INS quickly and accurately is a key issue to be solved. By taking the tilt RTK as an example, the present invention proposes a simple and effective heading initialization method, and it includes but is not limited to this application scenario.

### BRIEF SUMMARY OF THE INVENTION

In order to meet a demand in fast and accurate heading initialization of the INS during the application of low-speed motions and handheld devices and overcome shortcomings of the prior art, the present disclosure proposes a method for determining an initial heading error of the INS based on a trajectory comparing principle under the tilt RTK application scenario, so as to achieve heading angle initialization with an accuracy of 1 deg and complete the heading initialization within 2 seconds.

The present disclosure adopts the following technical solution, and provides a method for determining an initial heading error of the INS based on a trajectory comparing principle, which is mainly executed by shaking a measurement pole to form an IMU (Inertial Measurement Unit) motion trajectory and then calculating angular deviation of a RTK trajectory of the motion trajectory from an INS trajectory to thereby obtain the initial heading error of the INS. The technical solution includes following steps:

step 1: placing a measurement pole flatwise on a flat and clean ground, and remaining the measurement pole stationary for m minutes to determine a large gyro bias initial value;

step 2: raising the measurement pole to touch the ground with a pole tip of the measurement pole, and then titling the measurement pole to get ready for shaking, wherein the measurement pole remains stationary for m seconds before the shaking to determine an initial roll angle and an initial pitch angle; and

step 3: shaking a top end of the measurement pole while the measurement pole touches the ground and the pole tip remains stationary to form a motion trajectory, which is called IMU trajectory, and then obtaining an initial heading error of an INS by the following steps:

31) obtaining a position of an antenna phase center through RTK, and projecting the position to an IMU center to form a trajectory, which is called RTK trajectory;

32) calculating a position of the IMU center from a measurement value obtained by a positioning sensor to form a trajectory, which is called INS trajectory; and

33) comparing the RTK trajectory with the INS trajectory to calculate an initial heading angle error of the INS.

Furthermore, the step 32) is specifically implemented by:

describing a relationship between an IMU position of the tilt RTK and a position of the pole tip of the measurement pole, as follows:

r_{T}ⁿ=r_{IMU}ⁿ+C_{b}ⁿl^{b} (1)

where n represents a local coordinate system that is a frame n taking an IMU measurement center as an origin, in which an x-axis is parallel to a local horizontal plane and directed to due north, a y-axis is parallel to the local horizontal plane and directed to due east, and a z-axis is perpendicular to the local horizontal plane and directed downwards, so that the three axes constitute a right-hand coordinate system; b represents a body coordinate system that is a frame b taking the IMU measurement center as an origin, in which an x-axis is directed to a forward direction of a carrier, a y-axis is perpendicular to the x-axis and directed to a right side of the carrier, and a z-axis is perpendicular to both of the x-axis and the y-axis to form a right-hand coordinate system; r_{T}ⁿ represents a vector of the position of the pole tip, which is projected on the frame n, and T represents the pole tip; r_{IMU}ⁿ represents a vector of the IMU position projected in the frame n; C_{b}ⁿ represents an attitude matrix; and l^{b} represents a lever arm vector under frame b directing to the pole tip from the IMU center;

further rewriting estimation formula of the IMU position as:

r_{IMU}ⁿ(t)=r_{T}ⁿ−C_{b}ⁿ(t)l^{b} (2)

wherein only the attitude matrix C_{b}ⁿ at a right side of Formula (2) changes over time, and thereby estimation of the IMU position is completed as long as attitudes at each moment are obtained; wherein an attitude update algorithm is as follows:

q_{b(k)}^{n(k)}=qₙ₍ₖ₋₁₎^{n(k)}q_{b(k-1)}^{n(k-1)}q_{b(k)}^{b(k-1)} (3)

wherein the attitudes are updated through an attitude quaternion q in Formula (3), where k−1 represents a previous moment and k represents a current moment, such that the quaternion q_{b(k)}^{n(k)} of the frame b to the frame n at the current moment is further decomposed into three quaternions shown in Formula (3), wherein qₙ₍ₖ₋₁₎^{n(k)} and q_{b(k)}^{b(k-1)} represent attitude changes of the frame n and the frame b, respectively, and q_{b(k-1)}^{n(k-1)} represents a quaternion at the previous moment;

wherein updates of qₙ₍ₖ₋₁₎^{n(k)} are ignored, and attitude changes of the frame b are simplified as:

$$\begin{matrix}{q}_{b ( k )}^{b ( k - 1 )} = [ \begin{matrix}cos 0.5 ‖ {φ}_{k} ‖ \\ \frac{sin 0.5 ‖ {φ}_{k} ‖}{0.5 ‖ {φ}_{k} ‖} 0.5 {φ}_{k}\end{matrix} ] & ( 4 ) \\ {φ}_{k} = Δ {θ}_{k} + \frac{1}{12} Δ {θ}_{k - 1} \times Δ {θ}_{k} & ( 5 )\end{matrix}$$

where Δθₖ and Δθₖ₋₁ represent gyro angle incremental output at the current moment and the previous moment, respectively.

Furthermore, the step 33) is specifically implemented by:

denoting a coordinate system determined by the RTK trajectory as a reference coordinate system, which is a frame r; denoting a coordinate system determined by the INS trajectory as a calculation coordinate system, which is a frame c; simplifying the frame r and the frame c into two two-dimensional coordinate systems that are coplanar, an angle between the two coordinate systems being the initial heading angle error; and then, selecting three parameters, which are the initial heading angle error θ, a northward translation distance N, and an eastward translation distance E, to construct a coordinate transformation matrix as follows:

$${C}_{c}^{r} = [ \begin{matrix}cos θ & sin θ & N \\ - s in θ & cos θ & E\end{matrix} ] \qquad ( 6 )$$

where C_{c}^{r} represents a coordinate transformation matrix that transforms vectors from the frame c to the frame r; establishing an observation equation as follows according to a coordinate transformation principle:

s_{i,r}=C_{c}^{r}s_{i,c}+Δ (7)

where s_{i,r} and s_{i,c} represent plane projections of coordinate sequences of the RTK trajectory and the INS trajectory, respectively; i represents an i^{th} point on the RTK trajectory and the INS trajectory, where i=1, 2, 3, 4 . . . n; and Δ represents an observation error;

wherein although the coordinate transformation matrix C_{c}^{r} has 6 parameters, only three of which are independent parameters including the heading angle error θ, the northward translation distance N, and the eastward translation distance E, where are then taken as estimation parameters:

$${X}^{k} = [ \begin{matrix}{θ}^{k} \\ {N}^{k} \\ {E}^{k}\end{matrix} ] , {x}^{k} = [ \begin{matrix}{θ}^{k} - {θ}^{k - 1} \\ {N}^{k} - {N}^{k - 1} \\ {E}^{k} - {E}^{k - 1}\end{matrix} ] = [ \begin{matrix}Δ θ \\ Δ N \\ Δ E\end{matrix} ] \qquad ( 8 )$$

where a superscript k represents the number of iterations;

expanding the observation equation according to Taylor's formula and discarding second-order and higher-order terms to obtain:

$${s}_{i , r} = {C}_{c}^{r} {s}_{i , c} + Δ = {C}_{c}^{2} {{\vert}_{X = {X}^{k - 1}} \cdot {s}_{i , c} + ( \frac{\partial {C}_{c}^{r}}{\partial θ} \cdot Δθ + \frac{\partial {C}_{c}^{r}}{\partial N} \cdot Δ N + \frac{\partial {C}_{c}^{r}}{\partial E} \cdot Δ E ) \vert}_{X = {X}^{k - 1}} \cdot {s}_{i , c} + Δ \\ wherein f ( {X}^{k - 1} ) = {C}_{c}^{r} {{\vert}_{X = {X}^{k - 1}} , {H}_{i}^{k} = [ \frac{\partial {C}_{c}^{r}}{\partial θ} \cdot {s}_{i , c} \frac{\partial {C}_{c}^{r}}{\partial N} \cdot {s}_{i , c} \frac{\partial {C}_{c}^{r}}{\partial E} \cdot {s}_{i , c} ] \vert}_{X = {X}^{k - 1}} \qquad ( 9 )$$

simplifying the Formula (9) as:

s_{i,r}=f(X^{k-1})·s_{i,c}+Hᵢ^{k}·x^{k}+Δ (10)

wherein the Formula (9) is written in a residual equation form, which is:

$${v = H \cdot x - z = \\ [ \begin{matrix}\frac{\partial {C}_{c}^{r}}{\partial θ} \cdot {s}_{1 , c} & \frac{\partial {C}_{c}^{r}}{\partial N} \cdot {s}_{1 , c} & \frac{\partial {C}_{c}^{r}}{\partial E} \cdot {s}_{1 , c} \\ \frac{\partial {C}_{c}^{r}}{\partial θ} \cdot {s}_{2 , c} & \frac{\partial {C}_{c}^{r}}{\partial N} \cdot {s}_{2 , c} & \frac{\partial {C}_{c}^{r}}{\partial E} \cdot {s}_{2 , c} \\ ⋮ & ⋮ & ⋮ \\ \frac{\partial {C}_{c}^{r}}{\partial θ} \cdot {s}_{n , c} & \frac{\partial {C}_{c}^{r}}{\partial N} \cdot {s}_{n , c} & \frac{\partial {C}_{c}^{r}}{\partial E} \cdot {s}_{n , c}\end{matrix} ] \vert}_{X = {X}^{k - 1}} . [ \begin{matrix}Δθ \\ Δ N \\ Δ E\end{matrix} ] - \\ [ \begin{matrix}{s}_{1 , r} - f ( {X}^{k - 1} ) \cdot {s}_{1 , c} \\ {s}_{2 , r} - f ( {X}^{k - 1} ) \cdot {s}_{2 , c} \\ ⋮ \\ {s}_{n , r} - f ( {X}^{k - 1} ) \cdot {s}_{n , c}\end{matrix} ] \qquad ( 11 )$$

and

obtaining solution results by a least square method:

x=(H^{T}H)⁻¹H^{T}z (12)

X^{k}=X^{k-1}+x^{k} (13)

wherein an initial value of the least square method is obtained by a vector matching method.

Furthermore, the initial value of the least square method is obtained by:

selecting points on the RTK trajectory and the corresponding points on the INS trajectory under the same epoch to forming multiple pairs of vectors, obtaining angles between the multiple pairs of vectors, and then assigning different weights to the angles between the multiple pairs of vectors to determine an angle value of the initial heading angle error.

Furthermore, value of the m is 1.

The present disclosure has following advantageous effects.

(1) According to the present disclosure, the initial heading error of the INS is calculated by comparing the RTK trajectory with the INS trajectory. Since the RTK trajectory has a high accuracy and its errors are negligible, the heading angle accuracy is mainly affected by accuracy of the INS trajectory. The INS trajectory estimation method proposed by the present disclosure does not employ the accelerometer, which thereby prevents errors of the accelerometer from affecting the positioning accuracy and further leads errors of the INS trajectory to mainly come from a constant gyro bias. For the large gyro bias initial value, it can be determined and deducted by the standstill at the beginning. Thus, the present disclosure can realize the heading angle initialization with an accuracy of 1 deg, which has achieved a considerable accuracy for the aforesaid application scenarios.

(2) The method of the present disclosure is simple to operate and easy to implement. While shaking the measurement rod in situ, the larger the shaking amplitude (referring to the motion amplitude of the IMU at the top end), the better in theory. In actual operation, since length of the measurement rod is 2 meters, the shaking amplitude can easily reach 1 meter, which can already achieve a good initialization effect. In addition, the method of the present disclosure has no requirement on the shaking speed, and the shaking duration can be fed back to the terminal according to a real-time solution result of the system, and generally, the initialization can be completed in about two seconds. Thus, the operator only needs to complete the operation under prompts, which requires no extra work.

(3) The time spent by the initialization according to the method of the present disclosure is short, which thereby greatly improves the measurement efficiency. In the existing heading initialization methods for tilt RTK, the initialization may cost several seconds or even a dozen seconds and require to move several meters or even a dozen meters before accuracy of the heading initialization reaches the available level. However, the method of the present disclosure can achieve an initialization accuracy of 1 deg in only two seconds, which thereby greatly improves the operation efficiency.

(4) Compared with the common heading initialization methods for tilt RTK, the method of the present disclosure does not require a magnetometer, which thereby prevents the interference from the magnetic fields and has a stronger adaptability in complex environments.

### BRIEF DESCRIPTION OF THE SEVERAL VIEWS OF THE DRAWINGS

FIG. 1 is a schematic diagram of an IMU trajectory during initialization process for tilt RTK; and

FIG. 2 is a schematic diagram illustrating similarity between an INS trajectory and an GPS RTK trajectory.

### DETAILED DESCRIPTION OF THE INVENTION

The technical solution of the present disclosure will be further described in detail below in conjunction with the accompanying drawings and embodiments.

In an application scenario of the tilt RTK, the heading initialization is performed according to the method of the present disclosure after the user powers on the equipment. The specific steps are as follows.

1) A measurement pole is placed flatwise on a flat and clean ground after powering on the equipment, and remains stationary for 1 minute to determine a large gyro bias initial value.

2) The measurement pole is raised to touch the ground with a pole tip and then tilted to get ready for shaking. The measurement pole remains stationary for 1 second before the shaking to determine an initial roll angle and an initial pitch angle.

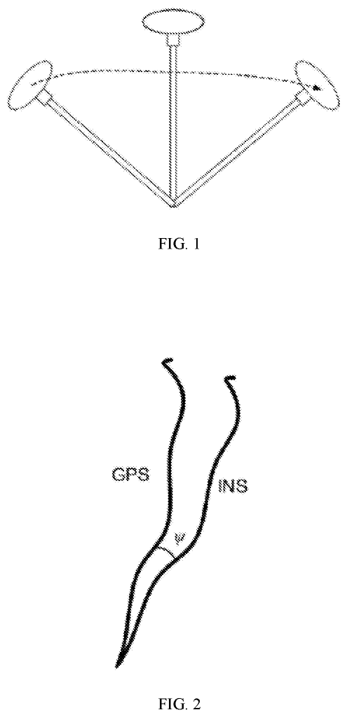

3) While the measurement pole touches the ground and the pole tip of the measurement pole remains stationary, a top end (i.e. IMU end) of the measurement pole is shaken to form a motion trajectory (called IMU trajectory), as shown in FIG. 1. At this time, the system performs real-time solution, and gives a prompt when the heading accuracy is reliable, so that the user may stop shaking. Generally, it only takes about 2 seconds of shaking to determine the initial heading of the INS.

The real-time solution of the system further includes the following sub-steps.

In sub-step 31), a position of an antenna phase center is obtained through RTK, and the position is projected to an IMU center to form a trajectory (called RTK trajectory).

In sub-step 32), a position of the IMU center is calculated from a measurement value obtained by a positioning sensor to form a trajectory (called INS trajectory). The present disclosure proposes the following solution method to determine the INS trajectory.

The relationship between an IMU position of the tilt RTK and a position of the pole tip of the measurement pole is described as follows:

r_{T}ⁿ=r_{IMU}ⁿ+C_{b}ⁿl^{b} (14)

In the formula, n represents a local coordinate system that is a frame n taking an IMU measurement center as an origin, in which an x-axis is parallel to a local horizontal plane and directed to due north, a y-axis is parallel to the local horizontal plane and directed to due east, and a z-axis is perpendicular to the local horizontal plane and directed downwards, so that the three axes constitute a right-hand coordinate system; b represents a body coordinate system that is a frame b taking the IMU measurement center as an origin, in which an x-axis is directed to a forward direction of a carrier, a y-axis is perpendicular to the x-axis and directed to a right side of the carrier, and a z-axis is perpendicular to both of the x-axis and the y-axis to form a right-hand coordinate system; r_{T}ⁿ represents a vector of the position of the pole tip, which is projected on the frame n, and T represents the pole tip (pole bottom); r_{IMU}ⁿ represents a vector of the IMU position projected in the frame n; C_{b}ⁿ represents an attitude matrix; and l^{b} represents a lever arm vector under the frame b directing to the pole tip from the IMU center. Wherein the position is in a form of north-east-down (planar coordinates and elevation).

In motions as designed in the initial alignment, r_{T}ⁿ does not change over time, and as long as a rough initial value of the position is given, the lever arm l^{b} in the formula may be accurately measured. Thus, the estimation formula of the IMU position may be rewritten as:

r_{IMU}ⁿ(t)=r_{T}ⁿ−C_{b}ⁿ(t)l^{b} (15)

At a right side of the formula, only the attitude matrix C_{b}ⁿ changes over time. Thus, the estimation of the IMU position is completed as long as the attitudes at each moment are obtained. An attitude update algorithm is as follows:

q_{b(k)}^{n(k)}=qₙ₍ₖ₋₁₎^{n(k)}q_{b(k-1)}^{n(k-1)}q_{b(k)}^{b(k-1)} (16)

The attitudes are updated through an attitude quaternion q in Formula (3), where k−1 represents a previous moment and k represents a current moment, such that the quaternion q_{b(k)}^{n(k)} of the frame b to the frame n at the current moment is further decomposed into three quaternions shown in Formula (3), wherein qₙ₍ₖ₋₁₎^{n(k)} and q_{b(k)}^{b(k-1)} represent attitude changes of the frame n and the frame b, respectively, and q_{b(k-1)}^{n(k-1)} represents a quaternion at the previous moment.

The attitude changes in the frame b may be simplified as:

$$\begin{matrix}{q}_{b ( k )}^{b ( k - 1 )} = [ \begin{matrix}cos 0.5 ‖ {φ}_{k} ‖ \\ \frac{sin 0.5 ‖ {φ}_{k} ‖}{0.5 ‖ {φ}_{k} ‖} 0.5 {φ}_{k}\end{matrix} ] & ( 17 ) \\ {φ}_{k} = Δ {θ}_{k} + \frac{1}{12} Δ {θ}_{k - 1} \times Δ {θ}_{k} & ( 18 )\end{matrix}$$

wherein Δθₖ and Δθₖ₋₁ are gyro angle incremental output at the current moment and the previous moment, respectively.

Since the initialization motion of tilt RTK has characteristics of small speed and limited position variation, the update of qₙ₍ₖ₋₁₎^{n(k)} may be simplified or even ignored. In this way, the main error that affects the INS trajectory is only the constant gyro bias, and the large gyro bias initial value may be determined by calculating the initial value through the standstill at the beginning.

In sub-step 33), assuming that the INS trajectory is only affected by the initial heading error without considering errors of other sensors, the INS trajectory is highly similar to the RTK trajectory, which is represented by two trajectories having substantially the same shape with one merely rotated by an angle, as shown in FIG. 2. This angle is the initial heading angle error of the INS. Thus, the initial heading error of the INS may be calculated by comparing the RTK trajectory with the INS trajectory, and the trajectory comparing algorithm includes but is not limited to vector matching method, least square method, etc. The specific implementation method is as follows.

A coordinate system determined by the RTK trajectory is denoted as a reference coordinate system, namely a frame r. A coordinate system determined by the INS trajectory is denoted as a calculation coordinate system, namely a frame c. The frame r and the frame care simplified into two two-dimensional coordinate systems that are coplanar, and an angle between the two coordinate systems is the initial heading angle error. Then, three parameters (initial heading angle error θ, northward translation distance N, and eastward translation distance E) are selected to convert the model and thereby achieve conversion of the coordinate system. The following coordinate transformation matrix may be constructed:

$${C}_{c}^{r} = [ \begin{matrix}cos θ & sin θ & N \\ - s in θ & cos θ & E\end{matrix} ] \qquad ( 19 )$$

where C_{c}^{r} represents a coordinate transformation matrix that transforms vectors from the frame c to the frame r. According to a coordinate transformation principle, an observation equation is established as follows:

s_{i,r}=C_{c}^{r}s_{i,c}+Δ (20)

In the formula, s_{i,r} and s_{i,c} are plane projections of coordinate sequences of the RTK trajectory and the INS trajectory, respectively; i (i=1, 2, 3, 4 . . . n) represents an i^{th} point on the RTK trajectory and the INS trajectory; and Δ is an observation error. It should be noted that since the coordinate transformation matrix C_{c}^{r} contains translation information, s_{i,c} which is two-dimensional originally is expanded as a three-dimensional vector.

Although the coordinate conversion matrix C_{c}^{r} has 6 parameters, only three of which are independent parameters including initial heading angle error θ, northward translation distance N, and eastward translation distance E, which are then taken as estimation parameters:

$${X}^{k} = [ \begin{matrix}{θ}^{k} \\ {N}^{k} \\ {E}^{k}\end{matrix} ] , {x}^{k} = [ \begin{matrix}{θ}^{k} - {θ}^{k - 1} \\ {N}^{k} - {N}^{k - 1} \\ {E}^{k} - {E}^{k - 1}\end{matrix} ] = [ \begin{matrix}Δ θ \\ Δ N \\ Δ E\end{matrix} ] \qquad ( 21 )$$

In the formula, the superscript k represents the number of iterations.

A following equation is obtained by expanding the observation equation according to Taylor's formula and discarding second-order and higher-order terms:

$${s}_{i , r} = {C}_{c}^{r} {s}_{i , c} + Δ = {C}_{c}^{2} {{\vert}_{X = {X}^{k - 1}} \cdot {s}_{i , c} + ( \frac{\partial {C}_{c}^{r}}{\partial θ} \cdot Δθ + \frac{\partial {C}_{c}^{r}}{\partial N} \cdot Δ N + \frac{\partial {C}_{c}^{r}}{\partial E} \cdot Δ E ) \vert}_{X = {X}^{k - 1}} \cdot {s}_{i , c} + Δ \\ f ( {X}^{k - 1} ) = {C}_{c}^{r} {{\vert}_{X = {X}^{k - 1}} , {H}_{i}^{k} = [ \frac{\partial {C}_{c}^{r}}{\partial θ} \cdot {s}_{i , c} \frac{\partial {C}_{c}^{r}}{\partial N} \cdot {s}_{i , c} \frac{\partial {C}_{c}^{r}}{\partial E} \cdot {s}_{i , c} ] \vert}_{X = {X}^{k - 1}} \qquad ( 22 )$$

The aforesaid formula may be simplified as:

s_{i,r}=f(X^{k-1})·s_{i,c}+Hᵢ^{k}·x^{k}+Δ (23)

The formula in a residual equation form is:

$${v = H \cdot x - z = \\ [ \begin{matrix}\frac{\partial {C}_{c}^{r}}{\partial θ} \cdot {s}_{1 , c} & \frac{\partial {C}_{c}^{r}}{\partial N} \cdot {s}_{1 , c} & \frac{\partial {C}_{c}^{r}}{\partial E} \cdot {s}_{1 , c} \\ \frac{\partial {C}_{c}^{r}}{\partial θ} \cdot {s}_{2 , c} & \frac{\partial {C}_{c}^{r}}{\partial N} \cdot {s}_{2 , c} & \frac{\partial {C}_{c}^{r}}{\partial E} \cdot {s}_{2 , c} \\ ⋮ & ⋮ & ⋮ \\ \frac{\partial {C}_{c}^{r}}{\partial θ} \cdot {s}_{n , c} & \frac{\partial {C}_{c}^{r}}{\partial N} \cdot {s}_{n , c} & \frac{\partial {C}_{c}^{r}}{\partial E} \cdot {s}_{n , c}\end{matrix} ] \vert}_{X = {X}^{k - 1}} . [ \begin{matrix}Δθ \\ Δ N \\ Δ E\end{matrix} ] - \\ [ \begin{matrix}{s}_{1 , r} - f ( {X}^{k - 1} ) \cdot {s}_{1 , c} \\ {s}_{2 , r} - f ( {X}^{k - 1} ) \cdot {s}_{2 , c} \\ ⋮ \\ {s}_{n , r} - f ( {X}^{k - 1} ) \cdot {s}_{n , c}\end{matrix} ] \qquad ( 24 )$$

Through the least square method, following solution results are obtained:

x=(H^{T}H)⁻¹H^{T}z (25)

X^{k}=X^{k-1}+x^{k} (26)

The initial value of the least square method may be, but not limited to, given by the vector matching method, and the specific steps are as follows. Multiple pairs of vectors are formed by the selected points on the RTK trajectory and the selected corresponding points on the INS trajectory under the same epoch. For example, assuming that the starting time of initial alignment is 9:00, coordinates of three time points, which are 9:00, 9:01 and 9:02, may be obtained after shaking for 2 seconds. The points on the RTK trajectory and the INS trajectory at the same time point are the corresponding points, and the three points on any trajectory may form 3 vectors in total, and the vectors on different trajectories may form 3 pairs of vectors. In theory, the angle between each pair of vectors is the angle between the two trajectories. After obtaining the angle between the multiple pairs of vectors, weights are assigned according to a certain criterion to determine an angle value of the initial heading angle error. The criterion here includes but is not limited to a vector length, time sequence, etc.

The specific embodiments described herein merely illustrate the spirit of the present invention exemplarily. Various modifications or additions may be made to the described embodiments, or alternatives may be employed, by those skilled in the art, without departing from the spirit of the present invention or going beyond the scope defined by the appended claims.

What is claimed is:

1. A heading initialization method for a tilt RTK, comprising:
step 1 of placing a measurement pole flatwise on a flat and clean ground, and remaining the measurement pole stationary for m minutes to determine a large gyro bias initial value;
step 2 of raising the measurement pole to touch the ground with a pole tip of the measurement pole, and then titling the measurement pole to get ready for shaking, wherein the measurement pole remains stationary for m seconds before the shaking to determine an initial roll angle and an initial pitch angle; and
step 3 of shaking a top end of the measurement pole while the measurement pole touches the ground and the pole tip remains stationary, to form a motion trajectory, which is called IMU trajectory, and then obtaining an initial heading error of an INS by following steps:
31) obtaining a position of an antenna phase center through RTK, and projecting the position to an IMU center to form a trajectory, which is called RTK trajectory;
32) calculating a position of the IMU center from a measurement value obtained by a positioning sensor to form a trajectory, which is called INS trajectory; and
33) comparing the RTK trajectory with the INS trajectory to calculate an initial heading angle error of the INS.

2. The heading initialization method for the tilt RTK according to claim 1, wherein the step 32) is specifically implemented by:
describing a relationship between an IMU position of the tilt RTK and a position of the pole tip of the measurement pole by below Formula (1):
r_{T}ⁿ=r_{IMU}ⁿ+C_{b}ⁿl^{b} (1)
wherein n represents a local coordinate system that is a frame n taking an IMU measurement center as an origin, in which an x-axis is parallel to a local horizontal plane and directed to due north, a y-axis is parallel to the local horizontal plane and directed to due east, and a z-axis is perpendicular to the local horizontal plane and directed downwards, so that the x-axis, y-axis and z-axis constitute a right-hand coordinate system; b represents a body coordinate system that is a frame b taking the IMU measurement center as an origin, in which an x-axis is directed to a forward direction of a carrier, a y-axis is perpendicular to the x-axis of the body coordinate system and directed to a right side of the carrier, and a z-axis is perpendicular to both of the x-axis and the y-axis of the body coordinate system to form a right-hand coordinate system; r_{T}ⁿ represents a vector of the position of the pole tip, which is projected on the frame n, wherein T represents the pole tip; r_{IMU}ⁿ represents a vector of the IMU position projected in the frame n; C_{b}ⁿ represents an attitude matrix; and l^{b} represents a lever arm vector under the frame b directing to the pole tip from the IMU center;
further rewriting estimation formula of the IMU position as:
r_{IMU}ⁿ(t)=r_{T}ⁿ−C_{b}ⁿ(t)l^{b} (2)
wherein only the attitude matrix C_{b}ⁿ at a right side of Formula (2) changes over time, and thereby estimation of the IMU position is completed as long as attitudes at each moment are obtained; wherein an attitude update algorithm is represented by Formula (3):
q_{b(k)}^{n(k)}=qₙ₍ₖ₋₁₎^{n(k)}q_{b(k-1)}^{n(k-1)}q_{b(k)}^{b(k-1)} (3)
wherein the attitudes are updated through an attitude quaternion q in Formula (3), where k−1 represents a previous moment and k represents a current moment, such that the quaternion q_{b(k)}^{n(k)} of the frame b to the frame n at the current moment is further decomposed into three quaternions shown in Formula (3), wherein qₙ₍ₖ₋₁₎^{n(k)} and q_{b(k)}^{b(k-1)} represent attitude changes of the frame n and the frame b, respectively, and q_{b(k-1)}^{n(k-1)} represents a quaternion at the previous moment;
wherein updates of qₙ₍ₖ₋₁₎^{n(k)} are ignored, and attitude changes of the frame b are simplified as:
$$\begin{matrix}{q}_{b ( k )}^{b ( k - 1 )} = [ \begin{matrix}cos 0.5 ‖ {φ}_{k} ‖ \\ \frac{sin 0.5 ‖ {φ}_{k} ‖}{0.5 ‖ {φ}_{k} ‖} 0.5 {φ}_{k}\end{matrix} ] & ( 4 ) \\ {φ}_{k} = Δ {θ}_{k} + \frac{1}{12} Δ {θ}_{k - 1} \times Δ {θ}_{k} & ( 5 )\end{matrix}$$
wherein Δθₖ and Δθₖ₋₁ represent gyro angle incremental output at the current moment and the previous moment, respectively.

3. The heading initialization method for the tilt RTK according to claim 1, wherein the step 33) is specifically implemented as by:
denoting a coordinate system determined by the RTK trajectory as a reference coordinate system, which is a frame r; denoting a coordinate system determined by the INS trajectory as a calculation coordinate system, which is a frame c; simplifying the frame r and the frame c into two two-dimensional coordinate systems that are coplanar, an angle between the reference coordinate system and the calculation coordinate system being the initial heading angle error; and then selecting three parameters which are the initial heading angle error θ, a northward translation distance N, and an eastward translation distance E, to construct a coordinate transformation matrix (6):
$${C}_{c}^{r} = [ \begin{matrix}cos θ & sin θ & N \\ - s in θ & cos θ & E\end{matrix} ] \qquad ( 6 )$$
where C_{c}^{r} represents a coordinate transformation matrix that transforms vectors from the frame c to the frame r;
establishing an observation equation (7) according to a coordinate transformation principle:
s_{i,r}=C_{c}^{r}s_{i,c}+Δ (7)
where s_{i,r} and s_{i,c} represent plane projections of coordinate sequences of the RTK trajectory and the INS trajectory, respectively; i represents an i^{th} point on the RTK trajectory and the INS trajectory, where 1=1, 2, 3, 4 . . . n; and Δ represents an observation error;
wherein although the coordinate transformation matrix C_{c}^{r} has 6 parameters, only three of which are independent parameters including the heading angle error θ, the northward translation distance N, and the eastward translation distance E, which are then taken as estimation parameters:
$${X}^{k} = [ \begin{matrix}{θ}^{k} \\ {N}^{k} \\ {E}^{k}\end{matrix} ] , {x}^{k} = [ \begin{matrix}{θ}^{k} - {θ}^{k - 1} \\ {N}^{k} - {N}^{k - 1} \\ {E}^{k} - {E}^{k - 1}\end{matrix} ] = [ \begin{matrix}Δ θ \\ Δ N \\ Δ E\end{matrix} ] \qquad ( 8 )$$
where a superscript k represents the number of iterations;
expanding the observation equation according to Taylor's formula and discarding second-order and higher-order terms to obtain:
$${s}_{i , r} = {C}_{c}^{r} {s}_{i , c} + Δ = {C}_{c}^{2} {{\vert}_{X = {X}^{k - 1}} \cdot {s}_{i , c} + ( \frac{\partial {C}_{c}^{r}}{\partial θ} \cdot Δθ + \frac{\partial {C}_{c}^{r}}{\partial N} \cdot Δ N + \frac{\partial {C}_{c}^{r}}{\partial E} \cdot Δ E ) \vert}_{X = {X}^{k - 1}} \cdot {s}_{i , c} + Δ \\ wherein f ( {X}^{k - 1} ) = {C}_{c}^{r} {{\vert}_{X = {X}^{k - 1}} , {H}_{i}^{k} = [ \frac{\partial {C}_{c}^{r}}{\partial θ} \cdot {s}_{i , c} \frac{\partial {C}_{c}^{r}}{\partial N} \cdot {s}_{i , c} \frac{\partial {C}_{c}^{r}}{\partial E} \cdot {s}_{i , c} ] \vert}_{X = {X}^{k - 1}} \qquad ( 9 )$$
simplifying the Formula (9) as:
s_{i,r}=f(X^{k-1})·s_{i,c}+Hᵢ^{k}·x^{k}+Δ (10)
wherein the Formula (9) is written in a residual equation form, which is:
$${v = H \cdot x - z = \\ [ \begin{matrix}\frac{\partial {C}_{c}^{r}}{\partial θ} \cdot {s}_{1 , c} & \frac{\partial {C}_{c}^{r}}{\partial N} \cdot {s}_{1 , c} & \frac{\partial {C}_{c}^{r}}{\partial E} \cdot {s}_{1 , c} \\ \frac{\partial {C}_{c}^{r}}{\partial θ} \cdot {s}_{2 , c} & \frac{\partial {C}_{c}^{r}}{\partial N} \cdot {s}_{2 , c} & \frac{\partial {C}_{c}^{r}}{\partial E} \cdot {s}_{2 , c} \\ ⋮ & ⋮ & ⋮ \\ \frac{\partial {C}_{c}^{r}}{\partial θ} \cdot {s}_{n , c} & \frac{\partial {C}_{c}^{r}}{\partial N} \cdot {s}_{n , c} & \frac{\partial {C}_{c}^{r}}{\partial E} \cdot {s}_{n , c}\end{matrix} ] \vert}_{X = {X}^{k - 1}} . [ \begin{matrix}Δθ \\ Δ N \\ Δ E\end{matrix} ] - \\ [ \begin{matrix}{s}_{1 , r} - f ( {X}^{k - 1} ) \cdot {s}_{1 , c} \\ {s}_{2 , r} - f ( {X}^{k - 1} ) \cdot {s}_{2 , c} \\ ⋮ \\ {s}_{n , r} - f ( {X}^{k - 1} ) \cdot {s}_{n , c}\end{matrix} ] \qquad ( 11 )$$
and
obtaining solution results by a least square method:
x=(H^{T}H)⁻¹H^{T}z (12)
X^{k}=X^{k-1}+x^{k} (13)
wherein an initial value of the least square method is obtained by a vector matching method.

4. The heading initialization method for the tilt RTK according to claim 3, wherein the initial value of the least square method is obtained by:
selecting points on the RTK trajectory and the corresponding points on the INS trajectory under the same epoch to form multiple pairs of vectors, obtaining angles between the multiple pairs of vectors, and then assigning different weights to the angles between the multiple pairs of vectors to determine an angle value of the initial heading angle error.
